(19) United States
(12) Patent Application Publication
(10) Pub. No.: US 2026/0253584 A1
(43) Pub. Date: Aug. 27, 2026

(54) UTTERANCE FILTERING DEVICE, DIALOGUE SYSTEM, CONTEXT MODEL TRAINING DATA PREPARING DEVICE AND COMPUTER PROGRAM

(71) Applicant: National Institute of Information and Communications Technology, Tokyo (JP)

(72) Inventors: Kentaro TORISAWA, Tokyo (JP); Junta MIZUNO, Tokyo (JP); Julien KLOETZER, Tokyo (JP); Mana KAMAKURA, Tokyo (JP)

(73) Assignee: National Institute of Information and Communications Technology, Tokyo (JP)

(21) Appl. No.: 18/878,064

(22) PCT Filed: Jun. 16, 2023
(86) PCT No.: PCT/JP2023/022349

§ 371 Date: Dec. 22, 2024

(30) Foreign Application Priority Data
Jul. 15, 2022 (JP) 2022-114229

(51) Int. Cl. G10L 15/22; G06F 16/9032

(52) U.S. Cl. CPC G10L 15/22; G06F 16/90332

(57) ABSTRACT

In a dialogue system outputting utterances in a dialogue manner, an utterance filtering device for preventing output of possibly problematic expression includes: a pre-trained context model trained, in response to an input of a word vector sequence representing an utterance, to output a probability vector comprising elements indicating probability of each of the words in a prescribed word group appearing in a context in which the utterance is placed; and a determining unit 456 configured to input a word vector sequence representing a subject utterance to the context model, and to determine whether the subject utterance is to be discarded or approved depending on whether a value determined as a prescribed function of a probability vector output by the context model in response to the input is equal to or larger than a threshold value.

### TECHNICAL FIELD

The present invention relates to a dialogue device and, more specifically, to a technique for determining whether or not a system utterance generated by the dialogue device includes any inadequate expression. The present application claims convention priority on Japanese Patent Application No. 2022-114229 filed on Jul. 15, 2022, the entire contents of which Japanese application is incorporated herein by reference.

### BACKGROUND ART

Systems that involve some form of user-system dialogue, such as a search engine, a question-answering system and a dialogue system, come to be widely used. In such a system, it is desirable that system response (hereinafter referred to as “system utterance”) does not include any inadequate expression.

A direct means to cope with this problem is to list problematic keywords. From the head of a system utterance candidate, whether any of such keywords exists or not is examined. If there is any such keyword in the system utterance candidate, the candidate is discarded, and the next system utterance candidate is selected. In this manner, if a system utterance candidate that does not include any one of the listed keywords is found, that system utterance candidate is output.

Patent Literature 1 below discloses this technique. According to the technique disclosed in Patent Literature 1, when dynamic content is displayed by a browser, the browser determines whether or not any problematic expression such as hate speech exists in the dynamic content.

### CITATION LIST

### Patent Literature

PTL 1: JPA 2022-082538

### SUMMARY OF INVENTION

### Technical Problem

The technique disclosed in Patent Literature 1 is that when a browser displays dynamic content, upon reception of the dynamic content from an application, the browser transmits it to a server that checks the content and receives the result of checking from the server. For the determination by the server, the afore-mentioned list of problematic keywords is used.

The technique of Patent Literature 1 relates to determination of the content as a whole. Therefore, if there is any problematic expression in the content, it is possible to stop displaying that part, or to stop displaying the whole content.

In contrast, generally, an output of dialogue system consists of one utterance. Therefore, when the technique of Patent Literature 1 is to be applied to a dialogue system, if a system utterance includes a problematic keyword, the utterance is not output; otherwise, the utterance is output.

In actual speech, however, even when the speech itself does not include any problematic keyword, it may be problematic enough when considered in its context. By way of example, you might refer to expressions such as “skin color” or “place of origin” as a problematic expression and, thereafter you can give a commentary on such expressions, or you can make a statement implying malice. In this case, even if the commentary itself is not malicious or the expression itself is not malicious, the output of such an expression might cause a problem. For example, if such an expression is output on a site providing public service, or on a corporate site, there is a risk of being criticized by users, even if the expression should not be considered a problem in view of preceding and following contexts. Outputs of question-answering systems and dialogue systems tend to be short expressions only and, therefore, by the technique of the system disclosed in Patent Literature 1 in which the whole contents are checked to determine whether or not to output, it is impossible to prevent output of possibly problematic expressions.

Therefore, an object of the present invention is to provide, in a dialogue-type system outputting an utterance in a dialogue format, an utterance filtering device preventing output of possibly problematic expressions.

### Solution to Problem

According to a first aspect, the present invention provides an utterance filtering device, including: a pre-trained context model trained, in response to an input of a word vector sequence representing an utterance, to output a probability comprising elements indicating probabilities of each of the words in a prescribed word group appearing in a context in which the utterance is placed; and a determining means configured to input a word vector sequence representing a subject utterance to the context model, and to determine whether the subject utterance is to be discarded or approved depending on whether at least one element of the probability vector output by the context model in response to the input satisfies a prescribed condition.

Preferably, the determining means includes a means for determining whether the subject utterance is to be discarded or approved, depending on whether a value determined as a prescribed function of at least one element of the probability vector is equal to or larger than a prescribed threshold value.

According to a second aspect, the present invention provides a dialogue system, including: a dialogue device; the above-described utterance filtering device, coupled to the dialogue device to receive as an input an utterance candidate output from the dialogue device; and an utterance filtering means for filtering the utterance output by the dialogue device, in accordance with the result of determination by the utterance filtering device.

According to a third aspect, the present invention provides a computer program causing a computer to function as: a pre-trained context model trained, in response to an input of a word vector sequence representing an utterance, to output a probability vector comprising elements indicating probability of each of the words in a prescribed word group appearing in a context in which the utterance is placed; and a determining means for inputting a word vector sequence representing an utterance to the context model, and based on the probability vector output from the context model in response to the input, for determining whether the subject utterance is to be discarded or approved depending on whether the probability of any word included in the prescribed word group is equal to or larger than a threshold value.

According to a fourth aspect, the present invention provides a training data preparing device, including: a context extracting means for extracting context of the utterance for each utterance stored in a corpus; a context vector generating means for generating a context vector representing whether or not each of the words included in a prescribed word group is appearing at least in the context; and a training data preparing means for preparing training data by combining the utterance as an input and the context vector as an output, for each utterance stored in the corpus.

Preferably, the context extracting means includes a preceding/succeeding utterance extracting means for extracting a context of each utterance stored in the corpus, the context including utterances preceding and succeeding the utterance.

More preferably, the context extracting means includes a succeeding utterance extracting means for extracting a context of each utterance stored in the corpus, the context including a following utterance immediately after the utterance stored in the corpus.

More preferably, the corpus includes a plurality of causality expressions each including a cause part and an effect part; and the context extracting means includes an effect part extracting means for extracting, for each of the plurality of causality expressions, the cause part of the causality expression as the utterance and the effect part of the causality expression as the context.

According to a fifth aspect, the present invention provides a computer program causing a computer to function as: a context extracting means for extracting context of each utterance stored in a corpus; a context vector generating means for generating a context vector representing whether or not each of the words included in a prescribed word group is appearing at least in the context; a training data preparing means, for each utterance stored in the corpus, for preparing training data by combining the utterance as an input and the context vector as an output; and a training means for training a context model formed of a neural network, using the training data generated by the training data preparing means.

The foregoing and other objects, features, aspects, and advantages of the present invention will become more apparent from the following detailed description of the present invention when taken in conjunction with the accompanying drawings.

### BRIEF DESCRIPTION OF DRAWINGS

FIG. 1 is a block diagram showing the configuration of a dialogue system in accordance with a first embodiment of the present invention.

FIG. 2 is a flowchart showing a control structure of a computer program realizing the training data preparing unit shown in FIG. 1.

FIG. 3 is a flowchart showing a control structure of a computer program realizing the steps shown in FIG. 2.

FIG. 4 is a block diagram showing a configuration of context model shown in FIG. 1.

FIG. 5 is a block diagram illustrating a scheme of training context model shown in FIG. 4.

FIG. 6 is a flowchart showing a control structure of a computer program realizing the dialogue device shown in FIG. 1.

FIG. 7 is a flowchart showing a control structure of a computer program corresponding to FIG. 6, in a modification of the first embodiment.

FIG. 8 is a block diagram showing the configuration of a dialogue system in accordance with a second embodiment of the present invention.

FIG. 9 is a flowchart showing a control structure of a computer program realizing the training data preparing unit shown in FIG. 8.

FIG. 10 is a flowchart showing a control structure of a computer program realizing part of the process shown in FIG. 9.

FIG. 11 is a block diagram showing a configuration of a dialogue system in accordance with a third embodiment of the present invention.

FIG. 12 is a flowchart showing a control structure of a computer program realizing the dialogue system shown in FIG. 11.

FIG. 13 shows the appearance of a computer realizing various embodiments of the present invention.

FIG. 14 is a hardware block diagram of the computer system of which appearance is shown in FIG. 13.

### DESCRIPTION OF EMBODIMENTS

In the following description and in the drawings, the same components are denoted by the same reference characters. Therefore, detailed description thereof will not be repeated.

### I. First Embodiment

### A. Configuration

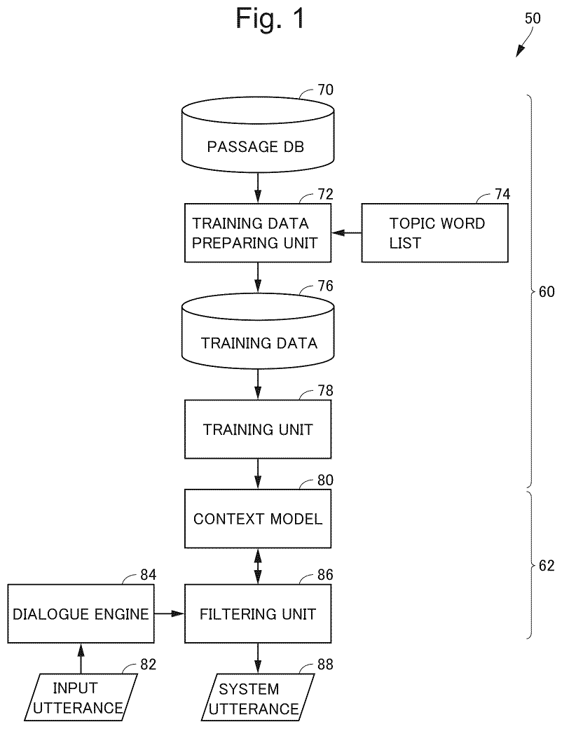

Referring to FIG. 1, a dialogue system 50 in accordance with the first embodiment of the present invention includes: a dialogue device 62; a context model 80 used in dialogue device 62 when system utterance candidates are filtered; a passage DB (Database) 70 for storing a plurality of passages; and a context model training system 60 for training context model 80 using each of the passages stored in passage DB 70.

Dialogue device 62 includes: a dialogue engine 84 receiving an input utterance 82 for generating and outputting a plurality of response candidates as responses to input utterance 82; and a filtering unit 86 for filtering the plurality of response candidates output by dialogue engine 84 by using context model 80, and outputting that response candidate which is determined by context model 80 to be free-of-problem and determined to be optimal as a response to input utterance 82, as a system utterance 88.

In the present embodiment, dialogue engine 84 has a function of: selecting a plurality of sentences considered to be appropriate as responses to input utterance 82 from sentences collected from the Internet; calculating, for each sentence, a score indicating appropriateness as a response to input utterance 82; and outputting a prescribed number of sentences having highest-ranking scores as response candidates. As the dialogue engine 84, by way of example, the dialogue system disclosed in JPA2019-197498 may be used. In the dialogue system described in this reference, system utterance candidates are selected from a large number of sentences collected beforehand. It is particularly noted that the larger the number of collected sentences, the higher the possibility that an appropriate response is found for the input utterance 82. Therefore, these substantial number of sentences are collected beforehand from the Internet. As is well known, many of the sentences on the Internet can involve problematic expressions. Therefore, the question is what kind of sentences are to be actually selected as system utterances.

Passage DB 70 stores a plurality of passages. Each of the passages includes a plurality of continuous sentences as a part of document. Each passage contains, for example, three to about nine sentences. In the present embodiment, the number of sentences contained in the passages stored in passage DB 70 varies. As mentioned above, these passages are all collected from the Internet in advance.

Context model training system 60 includes: a topic word list 74 listing pre-prepared topic words including problematic or possibly problematic expressions, keywords and concepts; and a training data preparing unit 72 for preparing training data for training context model 80 using each of the topic words stored in topic word list 74 based on each of the passages stored in passage DB 70. In the present embodiment, topic word list 74 is assumed to be a file having, for example, possibly problematic keywords separated by prescribed delimiters and recorded on a computer-readable storage medium. The number of topic words is given as N.

Context model training system 60 further includes: a training data storage unit 76 for storing the training data generated by training data preparing unit 72; and a training unit 78 for training unit 78 using the training data stored in training data storage unit 76.

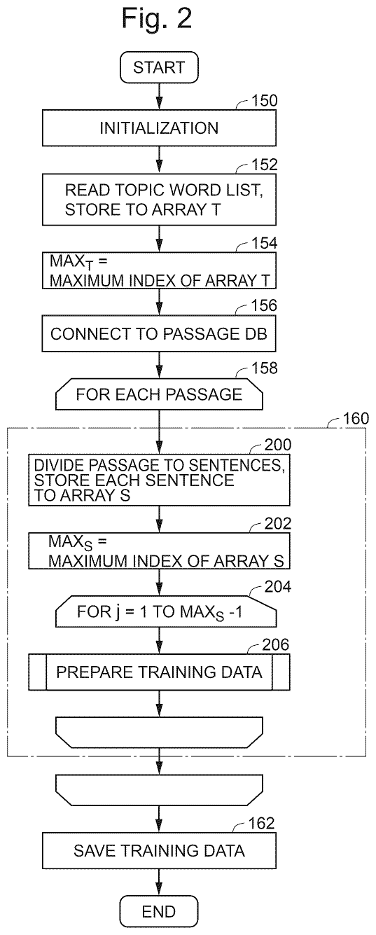

Training data preparing unit 72 shown in FIG. 1 is implemented by computer hardware and a computer program executed by the computer hardware. Referring to FIG. 2, the computer program includes: a step 150, after activation, of executing initialization process, including ensuring and initializing a memory area to be used by the program, opening a file to be used, reading initial parameters and setting parameters for accessing to the database; and a step 152 of reading the topic word list 74 shown in FIG. 1 from the file, splitting it at positions indicated by delimiters, and separating and storing the result as each of the elements of an array T in the memory.

The program further includes: a step 154 of inputting the maximum value of index of array T in a variable MAX_{T}; and a step 156 of connecting to passage DB 70 shown in FIG. 1. In the present embodiment, the index of array T starts from 0. In other words, the number of elements of array T is the value of variable MAX_{T}+1.

The program further includes: a step 158 of executing the following step 160 on each passage stored in passage DB 70 and thereby preparing training data for context model 80; and a step 162 of saving the training model generated at step 158 in training data storage unit 76 and ending execution of the program.

Step 160 includes: a step 200 of separating the subject passage to sentences and developing each sentence to an array S; and a step 202 of substituting the value of maximum index of array S for a variable MAX_{S}. Step 160 further includes a step 204 of executing the process of preparing training data of step 206, for each value of variable j from iteration control variable j=1 to j=MAX_{S}−1.

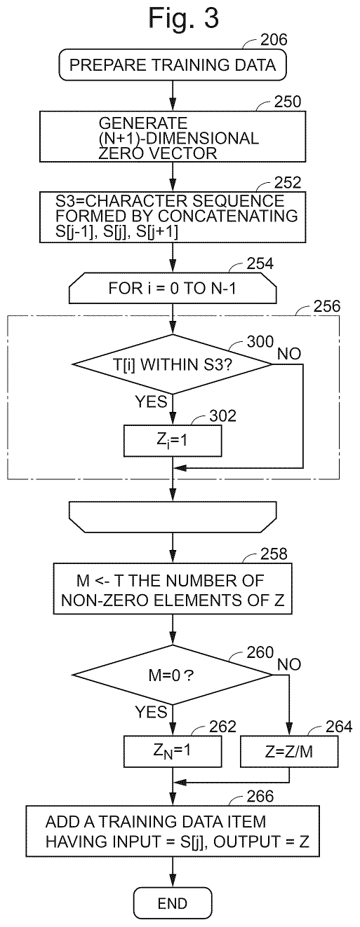

Referring to FIG. 3, step 206 shown in FIG. 2 includes: a step 250 of generating a (N+1)-dimensional vector Z the elements of which are all zeroes; a step 252 of substituting a string obtained by concatenating S[j−1], S[j] and S[j+1] for a string variable S3; and a step 254 of iteratively executing step 256 while varying the value of iteration variable i from i=0 to N−1, by a value of 1. Vector Z has N+1 elements, from element Z₀ to Z_{N}. As mentioned above, N is the number of topic words listed in topic word list 74 (see FIG. 1).

Step 256 includes: a step 300 of branching control flow depending on whether or not the target topic word, that is, the element T[i] having the index=0 of array T exists within the string represented by string variable S3; and a step 302, executed if the determination at step 300 is in the positive, of substituting 1 for the i-th element Zᵢ of vector Z. If the determination at step 300 is in the negative, or after step 302, step 256 ends.

Step 206 further includes: after the end of step 254, a step 258 of substituting the number of non-zero elements among the elements of vector Z for a variable M; and a step 260 of branching the control flow depending on whether or not the value of variable M is 0. Step 206 further includes: a step 262, executed if the determination at step 260 is in the positive, of substituting 1 for the (N+1)-th element of vector Z; a step 264, executed when the determination at step 260 is in the negative, of dividing vector Z by the value of variable M; and a step 266, following step 262 or 264, of adding a record of training data item having the j-th element of array S, that is, S[j], as an input, and vector Z as an output, to the training data and ending step 206.

If the process of step 262 is executed, only the (N+1)-th element Z_{N} among the elements of the vector Z will have the value 1 and all the other elements Zₖ (k=0 to N−1) will have the value 0. If step 264 is executed, of the elements of vector Z, an element Zₖ (k=0 to N−1) assumes the value 1/M if a topic word corresponding to that element exists in the string input to string variable S3 and assumes the value 0 otherwise. On the other hand, the element Z_{N} assumes the value 1 if there is no topic word corresponding to that element in the string input to string variable S3 and assumes the value 0 otherwise.

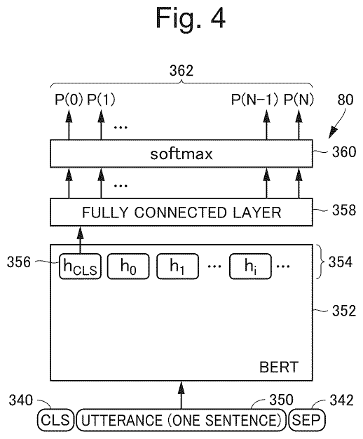

FIG. 4 shows a schematic configuration of context model 80. Referring to FIG. 4, context model 80 includes: BERT (Bidirectional Encoder Representations from Transformers) 352, which is a neural network receiving an input utterance 350 having a CLS token 340 at the head indicating the head of input, and a SEP token 342 at the tail indicating a break point of a sentence; and a fully connected layer 358 having N+1 outputs, connected to receive a vector comprising the contents of CLS corresponding layer 356 of the last hidden layer 354 of BERT 352, which is a transformer layer corresponding to CLS token 340. Context model 80 further includes a SoftMax layer 360, executing SoftMax operation on the N+1 outputs from fully connected layer 358 and outputting a probability vector 362. In the present embodiment, BERT 352 is a pre-trained BERT_{Large}.

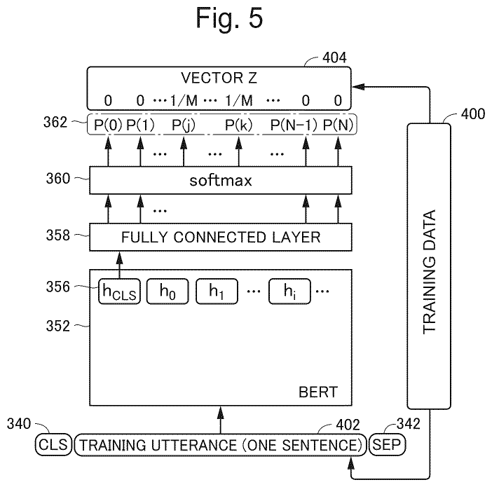

FIG. 5 shows an example of the relation between BERT 352 and the training data at the time of training of BERT 352. Referring to FIG. 5, as described above, training data 400 includes a sentence (element S[j] at the time of preparing training data) as an input and vector Z as an output (ground-truth data).

At the time of training, a sentence in training data 400 having CLS token 340 added at the head and SEP token 342 added at the tail is input to BERT 352. In response to this input, probability vector 362 is obtained at the output of SoftMax layer 360. By error back-propagation using the error between each element of probability vector 362 and ground-truth label vector 404 in training data 400, BERT 352 and fully connected layer 358 are trained.

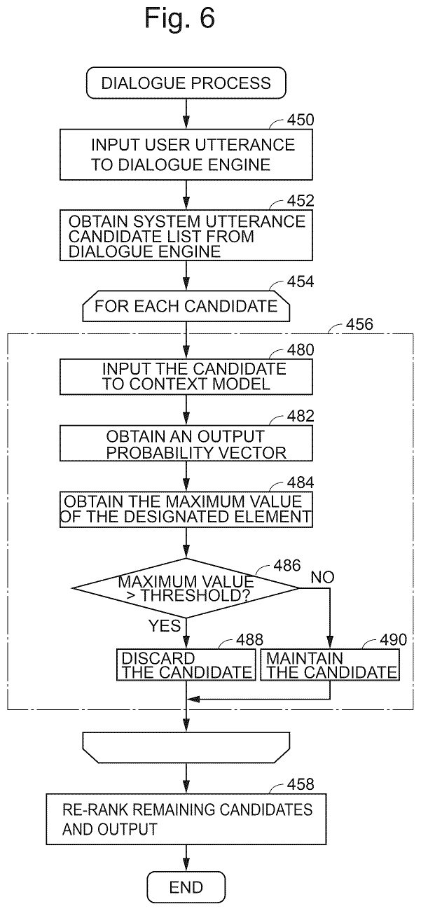

Referring to FIG. 6, the program realizing the filtering unit 86 shown in FIG. 1 includes: a step 450 of inputting an input utterance 82 to dialogue engine 84; and a step 452 of obtaining a system utterance candidate list output from dialogue engine 84 in response to the process at step 450.

The program further includes: a step 454 of executing a step 456 of determining, for each of the candidates in the system utterance candidate list obtained at step 452, whether it is appropriate as a system utterance, and if it is, approving and keeping it, and discarding if not; and after completing step 454, a step 458 of modifying the approved candidates to have a good format as a system utterance in response to input utterance 82, re-scoring and ranking them again, and outputting that system utterance candidate which has the highest score as the system utterance 88 (FIG. 1).

Step 456 includes: a step 480 of inputting a subject system utterance candidate to context model 80; a step 482 of obtaining probability vector 362 output from context model 80 as a result of processing at step 480; and a step 484 of obtaining the maximum value of element corresponding to one or more words labeled in advance as undesirable words, of the probability vector obtained at step 482.

Step 456 further includes: a step 486 of determining whether or not the value obtained at step 484 is larger than a prescribed threshold value and branching the control flow depending on the determination; a step 488, executed if the determination at step 486 is in the positive, of discarding the system utterance candidate as the object of processing and ending step 456; and step 490, executed if the determination at step 486 is in the negative, of approving and keeping the system utterance candidate as the object of processing and ending step 456.

### B. Operation

Dialogue system 50 in accordance with the above-described first embodiment operates as follows. The operation of dialogue system 50 includes a training phase and a dialogue phase. In the following, at first, the operation of dialogue system 50 (context model training system 60) in the training phase will be described. Thereafter, the operation of dialogue system 50 (dialogue device 62) in the dialogue phase will be described.

### B1. Training Phase

In the training phase, first, passage DB 70 is prepared. Each passage stored in passage DB 70 is, in the present embodiment, collected from the Internet. Similarly, topic word list 74 is also prepared. Topic word list 74 is, for example, a list of words of which frequency of appearance in the passage groups stored in passage DB 70 are higher than a prescribed threshold value. Specifically, this list can be automatically extracted, for example, from passage DB 70, by designating the threshold value. In the present embodiment, topic word list 74 is a file storing string obtained by separating each word by a prescribed delimiter.

Training data preparing unit 72 generates the training data from passage DB 70 with reference to topic word list 74, in the following manner.

Referring to FIG. 1, when context model training system 60 is activated, training data preparing unit 72 initializes various units of computer (step 150 of FIG. 2. In the following, the number of steps is that shown in FIG. 2 unless specified otherwise). In this process, training data preparing unit 72 sets a parameter to access to passage DB 70 and opens topic word list 74. Dialogue device 62 ensures memory area for arrays T and S, variables S3 and M, iteration control variables i and j, and vector Z.

Thereafter, training data preparing unit 72 reads topic word list 74, and while separating with the prescribed delimiter, stores the contents to respective elements of array T (step 152). Training data preparing unit 72 further inputs the maximum value of the index of array T to variable MAX_{T} (step 154). Thereafter, training data preparing unit 72 connects to passage DB 70 shown in FIG. 1 (step 156). In the present embodiment, the index of array T is from 0 to the value of variable MAX_{T}.

Training data preparing unit 72 further executes the following step 160 on each of the passages stored in passage DB 70 to generate records of training data (step 158).

At step 160, first, training data preparing unit 72 divides the passage as the object of processing to sentences and stores each sentence to each element of array S (step 200). Further, training data preparing unit 72 substitutes the value of maximum index of array S for variable MAX_{S} (step 202). Training data preparing unit 72 further executes, at step 204, step 206 for each value of variable j of iteration control variables j=1 to j=MAX_{S}−1, and thereby generates new records of training data.

Referring to FIG. 3, at step 206, training data preparing unit 72 generates vector Z of which elements are all zeroes (step 250 of FIG. 3). Specifically, at this step, vector Z is initialized. Thereafter, training data preparing unit 72 substitutes a string obtained by concatenating S[j−1], S[j] and S[j+1] for string variable S3 (step 252 of FIG. 3). Further, training data preparing unit 72 iteratively executes step 256 while varying the value of iteration variable i from i=0 to N−1, by a value of 1 (step 254 of FIG. 3).

At step 256, training data preparing unit 72 determines whether or not the subject element T[i] of the array T exists within the string represented by string variable S3 (step 300 of FIG. 3). If the determination at step 300 is in the positive, training data preparing unit 72 substitutes 1 for the i-th element Zᵢ of vector Z (step 302 of FIG. 3). If the determination at step 300 is in the negative, nothing is done.

Context model training system 60 executes step 256 while varying the value of iteration variable i from i=0 to N−1, by a value of 1. By this process, if the element T[i] exists in the string represented by string variable S3, the value of i-th element Zᵢ of vector Z will be 1, otherwise, the value of element Zᵢ will be 0.

When step 254 is finished, training data preparing unit 72 substitutes the number of non-zero elements of vector Z for variable M (step 258 of FIG. 3). Training data preparing unit 72 determines whether or not the value of variable M is 0 (step 260 of FIG. 3). If the determination at step 260 is in the positive, that is, if there is not a non-zero element among the elements of vector Z, training data preparing unit 72 substitutes 1 for the (N+1)-th element of vector Z (step 262 of FIG. 3). If the determination at step 260 is in the negative, that is, if there is at least one non-zero element in vector Z, training data preparing unit 72 divides vector Z by the value of variable M (step 264 of FIG. 3).

Execution of step 206 shown in FIG. 3 by context model training system 60 results in a vector Z in which, if at least one word in topic word list 74 exists in the string (value of string variable S3) obtained by concatenating a sentence represented by a certain value of variable j (1≤j≤MAX_{S}−1) and sentences preceding and succeeding that sentence of a passage, the element corresponding to that word of vector Z will have the value 1/M and the other elements the value 0. If none of the words in topic word list 74 exists in the string represented by string variable S3, the N-th element Z_{N} of vector Z will be 1 and all the other elements will have the value 0.

Thereafter, training data preparing unit 72 generates a new record of training data for element S[j], by combining element S[j] as an input with vector Z as an output, and adds it to training data storage unit 76 (step 266).

When generation of training data is completed, training unit 78 trains context model 80 using the training data.

Referring to FIG. 5, training of context model 80 by training unit 78 will be described. As described above, training data 400 includes a sentence (element S[j] at the time of training data generation) as an input and has vector Z as an output (ground-truth data). Training unit 78 shown in FIG. 1 reads one record of training data 400, adds CLS token 340 to the head and SEP token 342 to the tail of the sentence to generate a training utterance 402, which is input to BERT 352. BERT 352 operates this input and changes internal states of each of its hidden layers. Fully connected layer 358 receives an output vector of CLS corresponding layer 356 of the last hidden layer of BERT 352, and inputs N+1 outputs to SoftMax layer 360. The output of each position of fully connected layer 358 is a numerical value representing probability that the training utterance 402 is related to the word corresponding to that position, among the words listed in topic word list 74. Ground-truth label vector 404 performs SoftMax operation on these N+1 numerical values, and outputs a probability vector 362 comprised of N+1 elements P(0) to P(N).

Training unit 78 trains parameters of fully connected layer 358 and BERT 352 by error back-propagation, using error between the probability vector 362 and each element of ground-truth label vector 404 corresponding to training utterance 402. Actually, training unit 78 executes the above-described process repeatedly by mini-batch by mini-batch selected from the training data, until a prescribed end condition is satisfied. In the present embodiment, this training is done by minimizing the value of loss function shown below.

$$L = {\sum }_{i = 0}^{N} ( - Z ( i ) * log P ( i ) )$$

When training in this manner ends, it becomes possible to use context model 80 in dialogue device 62.

### B2. Dialogue Phase

Referring to FIG. 1, a user inputs input utterance 82 to dialogue engine 84. In response to the input utterance 82, dialogue engine 84 selects a plurality of system utterance candidates considered to be appropriate as a response to input utterance 82, from a large number of sentences collected from the Internet. Input utterance 82 calculates, by a prescribed scoring method, a score of each of the plurality of system utterance candidates and ranks these system utterance candidates in accordance with the scores. Input utterance 82 gives a prescribed number of highest ranking system utterance candidates to filtering unit 86.

In the present embodiment, filtering unit 86 inputs each system utterance candidate received from dialogue engine 84 to context model 80, and obtains as its output, a probability vector 362. Filtering unit 86 determines whether or not the probability value of that element of probability vector 362 which is pre-determined to be inappropriate as a system utterance is larger than a prescribed threshold value (step 486). If this determination is in the positive, filtering unit 86 discards the system utterance candidate (step 488). If this determination is in the negative, filtering unit 86 approves and keeps this system utterance candidate (step 490).

Filtering unit 86 modifies the system utterance candidates kept in this manner such that they have appropriate format as a response to input utterance 82. Filtering unit 86 newly scores the modified system utterance candidates, and outputs the system utterance candidate of the highest score as system utterance 88.

As described above, according to the present embodiment, a system utterance in a dialogue is selected considering not only the text itself of system utterance candidate but also the possibility of words appearing in its context. Generally, a system utterance is one sentence and actually, there is no preceding or succeeding context. Therefore, it is difficult to determine only from the system utterance whether or not the utterance might be problematic. According to the present embodiment, however, a system utterance is selected using information directed to what relation the system utterance may have with its preceding and succeeding context. Therefore, the possibility of any problem caused by outputting the system utterance can be reduced.

### C. Modification

In the first embodiment above, as shown by steps 484 to 490 of FIG. 6, whether a candidate is to be discarded or kept is determined depending on whether or not the maximum value of a designated element in the output probability vector is larger than the threshold value. Specifically, the value of output probability vector element is directly used for the determination. The present invention, however, is not limited to such an embodiment. When determining whether or not the probability value of the element pre-determined to be inappropriate as a system utterance is larger than the prescribed threshold value, not only one element but two or more elements of the probability vector may be used. When two or more of elements are used for determination, it is possible to determine by using a value of logical expression of conditions on the plurality of elements, for example, a positive determination may be made if values of two elements are both equal to or smaller than a prescribed threshold value, or if the other element is not lower than the prescribed threshold value. Alternatively, determination may be made in general by using a value obtained by inputting the one, two or more elements of probability vector to a prescribed function. Such a modification will be described in the following.

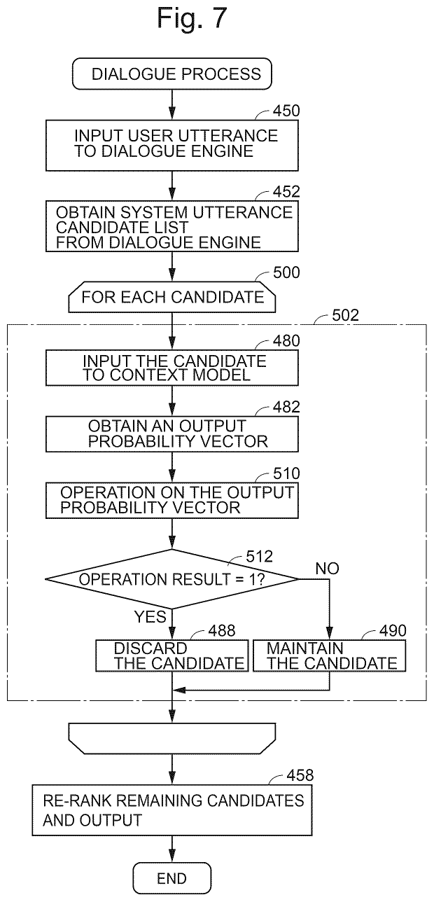

FIG. 7 shows a control structure of a program realizing the process corresponding to the process shown in FIG. 6, of the modification of the first embodiment. This program differs from that of FIG. 6 in that it includes a step 500 of executing a step 502 for each candidate, in place of step 454 of FIG. 6.

Referring to FIG. 7, step 502 includes: steps 480 and 482, which are the same as those of FIG. 6; a step 510 of executing a prescribed operation between elements of the output vector; and a step 512 of branching the control flow depending on whether the result of operation at step 510 is 1 or not. If the determination at step 512 is in the positive, that is, if the result of operation at step 510 is 1, the candidate under processing is discarded at step 488. If the determination at step 512 is in the negative, the candidate under processing is approved and kept at step 490.

The operation at step 510 is, in the present embodiment, realized by building a logic in accordance with a condition to be satisfied by the output probability vector in advance. When we represent the i-th element of output probability vector by ai, ai represents the probability that the i-th word in the topic word list appears around the system utterance candidate. Therefore, by performing the prescribed logical operation on the plurality of elements of output probability vector, it becomes possible to determine a complex condition as to whether or not the system utterance candidate as the object is to be discarded or to be maintained.

By way of example, for a condition “if the probability of (i−1)-th word and (i−2)-th word of the topic word list appear simultaneously around the system utterance candidate is higher than the threshold value, the system utterance candidate is discarded,” a logic “if aᵢ₁*aᵢ₂>threshold value, discard system utterance candidate” may be built in advance.

Specifically, by this modification also, the same effects as the first embodiment can be attained. In the modification, more complicated conditions can be set than in the first embodiment and, therefore, the intention of the system developer can be clearly reflected on the dialogue system operation.

In the first embodiment, the output probability vector is normalized such that the sum of the values of all elements comes to be 1 by SoftMax function. When the above-described operation is executed, if the threshold value can be well adjusted, the output vector of BERT before the input to SoftMax function may be directly used. Alternatively, the first embodiment and the modification above may be combined.

### 2. Second Embodiment

### A. Configuration

In the first embodiment, as shown in FIG. 1, for each passage stored in passage DB 70, the sentence as the object and the sentences immediately preceding and immediately following that sentence are used as context, to train the context model 80. In the second embodiment, only the expression following the expression as the object is used as the context of the expression to train the context model.

In the second embodiment, different from the first embodiment, the expression as the object and the immediately following expression as the context are selected to form a causal relation to prepare training data for the context model.

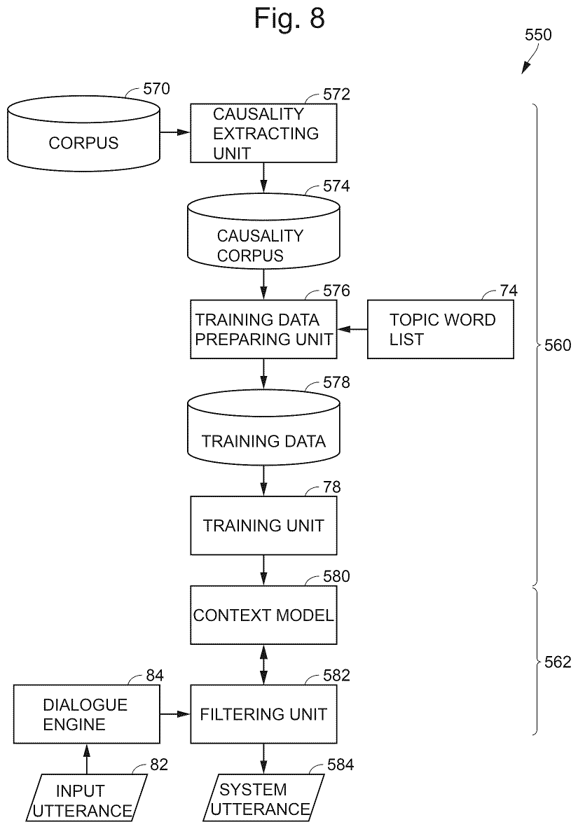

Referring to FIG. 8, a dialogue system 550 in accordance with the second embodiment includes: a context model 580; a context model training system 560; and a dialogue device 562 that filters system utterances by using trained context model 580 and outputs a system utterance 584 in response to an input utterance 82.

Context model training system 560 includes: a corpus 570 for storing a large number of expressions collected from the Internet; a causality extracting unit 572 for extracting a sentence or an expression representing causality from the corpus 570; and a causality corpus 574 for storing the causalities extracted by causality extracting unit 572.

The causality refers to a pair of phrases, including a cause phrase representing a cause of causal relation and an effect phrase representing the effect thereof. In the present embodiment, for a cause phrase, the corresponding effect phrase is used as the context for the cause phrase to generate the training data for training the context model 580.

Context model training system 560 further includes: a topic word list 74; a training data preparing unit 576 for preparing each record of training data by using each phrase pair stored in causality corpus 574 while referring to the topic word list 74; and a training data storage unit 578 for storing each record of the training data prepared by training data preparing unit 576.

Context model training system 560 further includes a training unit 78 for training context model 580 by the training data stored in training data storage unit 578.

As in the first embodiment, dialogue device 562 includes: a dialogue engine 84 that receives input utterance 82 and outputs a plurality of system utterance candidates; and a filtering unit 582 that filters the plurality of response candidates output from dialogue engine 84 by using context model 580, and outputs that response candidate which is determined to be non-problematic by context model 580 and determined to be optimal as a response to input utterance 82, as a system utterance 584.

As to the process of extracting causality from a corpus containing an enormous number of documents as executed by causality extracting unit 572, a technique disclosed, for example, in JP2018-060364A is applicable.

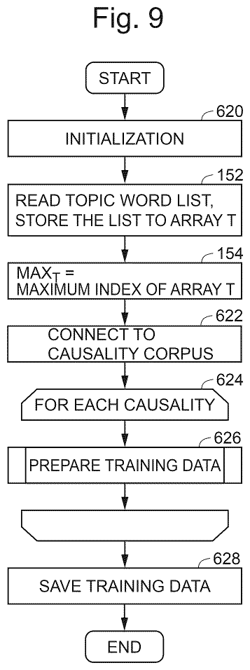

Referring to FIG. 9, the program executed by a computer to realize context model training system 560 shown in FIG. 8 includes: a step 620 of initialization immediately after activation; and a step 152 of reading topic word list 74 shown in FIG. 8 from the file, splitting it at positions indicated by delimiters, and separating and storing the results as respective elements of an array T in the memory.

The program further includes: a step 154 of inputting the maximum value of index of array T in variable MAX_{T}; a step 622 of connecting to causality corpus 574 shown in FIG. 8; a step 624 of executing step 626 on each of the causalities stored in causality corpus 574 to prepare training data; and a step 628 of storing the training data prepared at step 624 in training data storage unit 578 shown in FIG. 8 and ending the process.

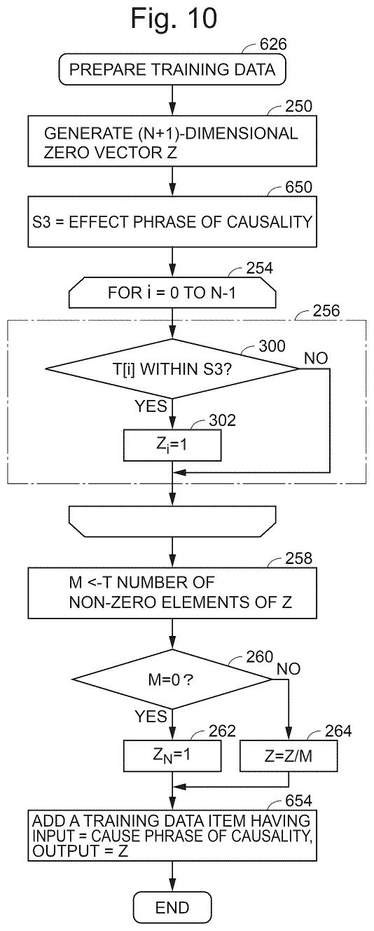

Referring to FIG. 10, step 626 shown in FIG. 9 has substantially the same control structure as the program realizing step 206 of the first embodiment shown in FIG. 3. Different from step 206, step 626 includes, in place of step 252 of FIG. 3, a step 650 of inputting an effect phrase of the causality as the object of processing to string variable S3. Further, different from step 206, step 626 includes, in place of step 266 of FIG. 3, a step 654 of adding a record of training data item that has a cause phrase of the causality as the object of processing as the input and vector Z as the output, to the training data, and ending step 626.

### B. Operation

Dialogue system 550 shown in FIG. 8 of the second embodiment operates in the following manner. The operation of dialogue system 550 includes the training phase and the dialogue phase. The configuration of dialogue device 562 in the dialogue phase is the same as that of dialogue device 62 of the first embodiment except that the used context model is different, and the operation is the same. Therefore, in the following, the operation of dialogue system 550 in the training phase (context model training system 560) will be described.

### B1. Training Phase

Prior to the training phase, a huge amount of text is stored in corpus 570. The text may be collected, for example, from the Internet. Causality extracting unit 572 extracts causalities from the huge amount of text and stores them in causality corpus 574.

Training data preparing unit 576 prepares training data by using each of the causalities stored in causality corpus 574 while referring to topic word list 74, and stores the training data in training data storage unit 578.

Referring to FIG. 8, when context model training system 560 is activated, training data preparing unit 576 initializes various units of the computer (step 620 of FIG. 9. In the following, the number of steps refers to the one in FIG. 9 unless indicated otherwise.). In this process, training data preparing unit 576 sets parameters for accessing to causality corpus 574, and opens topic word list 74. Further, training data preparing unit 576 ensures memory area for arrays T and S, variables S3 and M, iteration control variables i and j, and vector Z.

Thereafter, training data preparing unit 576 reads topic word list 74, and while splitting the list by prescribed delimiters, stores the contents to elements of array T (step 152). Further, training data preparing unit 576 substitutes the maximum value of index of array T for variable MAX_{T} (step 154). Thereafter, training data preparing unit 576 connects to causality corpus 574 shown in FIG. 8 (step 622). In the present invention also, the index of array T is from 0 to the value of variable MAX_{T}.

Further, training data preparing unit 576 executes the following step 626 on each of the causalities stored in causality corpus 574 to generate records of training data (step 624).

Referring to FIG. 10, at step 626, training data preparing unit 576 generates vector Z of which elements are all zeroes (step 250 of FIG. 10). Specifically, at this step, vector Z is initialized. Thereafter, training data preparing unit 576 substitutes the character sequence of the effect phase of subject causality for string variable S3 (step 650 of FIG. 10). Further, training data preparing unit 576 iteratively executes step 256 while varying the value of variable i from i=0 to N−1, by a value of 1 (step 254 of FIG. 10).

At step 256, training data preparing unit 576 determines whether or not the subject element T[i] of the array T exists in the string represented by string variable S3 (step 300 of FIG. 10). If the determination at step 300 is in the positive, training data preparing unit 576 inputs 1 to the i-th element Zᵢ of vector Z (step 302). If the determination at step 300 is in the negative, training data preparing unit 576 does no operation.

Training data preparing unit 576 executes step 256 while varying the value of iteration variable i from i=0 to N−1, by a value of 1. By this process, if the element T[i] exists in the character sequence represented by the string variable S3, the value of i-th element Zi of vector Z assumes 1, and otherwise the value of element Zi is 0.

After the end of step 254, training data preparing unit 576 substitutes the number of non-zero elements among the elements of vector Z for variable M (step 258 of FIG. 10). Training data preparing unit 576 determines whether or not the value of variable M is 0 (step 260). If the determination at step 260 is in the positive, that is, if there is no non-zero element among the elements of vector Z, training data preparing unit 576 substitutes 1 for the (N+1)-th element Z_{N} of vector Z (step 262 of FIG. 10). If the determination at step 260 is in the negative, that is, if there is at least one non-zero element in vector Z, training data preparing unit 576 divides vector Z by the value of variable M (step 264 of FIG. 10). Specifically, each element of vector Z is divided by the value of variable M.

As a result of this step 626 shown in FIG. 10 executed by training data preparing unit 576, if at least one word in topic word list 74 exists in an effect phrase of a certain causality, such a vector Z is obtained in that the value of element corresponding to that word in vector Z assumes 1/M and values of other elements assume 0. If none of the words in topic word list 74 exists in the string represented by string variable S3, the N-th element Z_{N} of vector Z becomes 1 and all other elements will be 0.

Thereafter, training data preparing unit 576 combines the cause phrase of the subject causality as an input and vector Z as an output to generate a new record of training data item corresponding to the subject causality and adds it to training data storage unit 578 shown in FIG. 8 (step 654).

Dialogue device 562 trains context model 580 using the training data prepared in this manner. The process by training unit 78 is the same as that of training unit 78 shown in FIG. 1, except that different training data is used.

### B2. Dialogue Phase

The dialogue process by dialogue device 562 in accordance with the second embodiment is the same as the process by filtering unit 86 in accordance with the first embodiment, except that in place of context model 80 of the first embodiment, the context model 580 trained by the above-described method is used.

As described above, by the second embodiment, an enormous number of causalities are prepared in advance, and by regarding the effect phrase of each causality as context of the cause phrase, the training data is prepared in the similar manner as in the first embodiment. By training context model 580 using the training data, as in the first embodiment, whether or not a system utterance is appropriate is determined considering not only the text itself of the system utterance candidate but also possibility of words appearing in the context. Generally, a system utterance is one sentence and actually, there is no preceding or succeeding context. Therefore, it is difficult to determine only from the system utterance whether or not the utterance might be problematic. According to the present embodiment, however, a system utterance is selected using information directed to what relation the system utterance may have with its preceding and succeeding context. Therefore, the possibility of any problem caused by outputting the system utterance can be reduced.

### 3. Third Embodiment

### A. Configuration

In the first and second embodiments above, when a system utterance candidate is input, basically, only the output of context model corresponding to the system utterance candidate is used to determine whether or not the system utterance candidate is to be maintained or discarded. The present invention, however, is not limited to such embodiments. In the third embodiment, similarity between a vector output from the context model corresponding to the system utterance candidate and a plurality of reference vectors prepared beforehand is examined, and if the similarity satisfies a certain condition, the system utterance candidate is discarded.

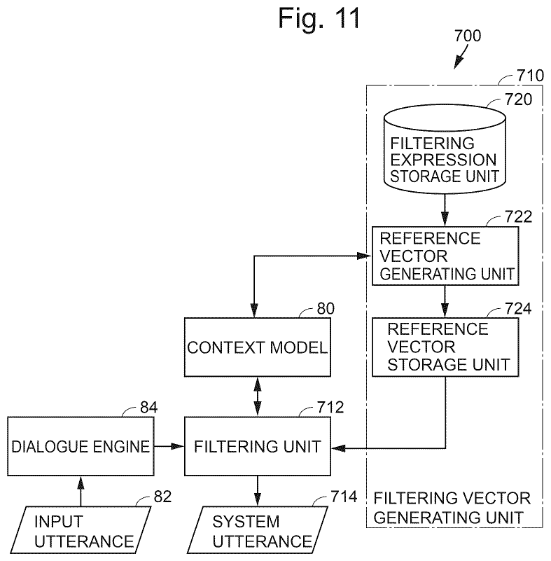

FIG. 11 is a block diagram showing a dialogue system 700 in accordance with the third embodiment of the present invention. Referring to FIG. 11, dialogue system 700 includes: dialogue engine 84 and context model 80 same as those used in the first embodiment; and a filtering unit 712 that examines, for a system utterance candidate output from dialogue engine 84, cosine similarity between an output probability vector output from context model 80 and a plurality of reference vectors prepared beforehand, maintains the system utterance candidate if the number of reference vectors of which cosine similarity is equal to or larger than a prescribed threshold value is smaller than a threshold value, and discards the system utterance candidate if not, and outputs a system utterance 714 based on the eventual scores. It is assumed that context model 80 is pre-trained in accordance with the method described with reference to the first embodiment.

Dialogue system 700 further includes a filtering vector generating unit 710 for generating and storing in advance the reference vectors to be used for filtering by filtering unit 712.

More specifically, filtering vector generating unit 710 includes: a filtering expression storage unit 720 for storing a plurality of expressions around which unpreferable expressions tend to appear frequently; a reference vector generating unit 722 for generating reference vectors consisting of output probability vectors of context model 80 for each expression, by inputting each of the expressions stored in filtering expression storage unit 720 to context model 80; and a reference vector storage unit 724 for storing the reference vectors generated by reference vector generating unit 722. Reference vector storage unit 724 is connected to filtering unit 712 to allow access from filtering unit 712.

The present embodiment is based on a finding that if there is high similarity between the output probability vector obtained from an expression having high possibility of unpreferable expressions appearing therearound and the output probability vector obtained from the system utterance candidate, it is highly possible that unpreferable expression or expressions appear around the system utterance candidate. Specifically, such a finding was essential to conceive the idea that it is undesirable to have such a system utterance candidate as an output of the dialogue system.

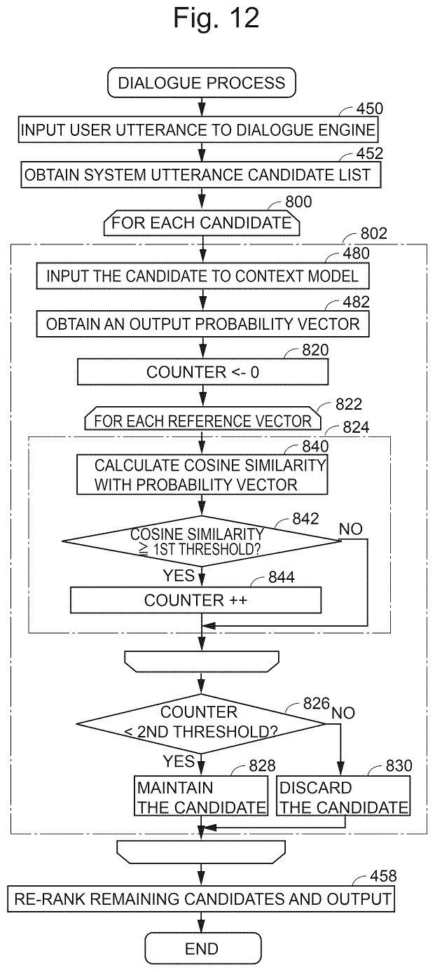

FIG. 12 is a flowchart showing a control structure of a computer program realizing the filtering unit 712 shown in FIG. 11 by a computer. Referring to FIG. 12, the program includes: steps 450 and 452 similar to those shown in FIG. 6; and a step 800 of executing a step 802 on each system utterance candidate.

Step 802 includes: steps 480 and 482 similar to those shown in FIG. 6; and a step 820 following step 482 of substituting 0 for a variable representing a counter. The counter is used in the following process to count the number of filtering expressions of which similarity with the probability vector obtained from the system utterance is equal to or higher than a threshold value.

Step 802 further includes: a step 824 of incrementing the counter by one if each reference vector is similar to the probability vector obtained from the system utterance candidate; a step 826, following the end of processing of step 822, of branching the control flow depending on whether or not the counter value is smaller than a second threshold value; a step 828 of maintaining the subject system utterance candidate if the determination at step 826 is in the positive; and a step 830 of discarding the system utterance candidate if the determination at step 826 is in the negative. By step 828 or step 830, step 802 ends.

Step 824 includes: a step 840 of calculating the cosine similarity between the object vector and the probability vector obtained from the system utterance candidate; a step 842 of branching the control flow depending on whether the cosine similarity calculated at step 840 is equal to or higher than a first threshold value; and a step 844, executed if the determination at step 842 is in the positive, of incrementing the counter value by one and ending execution of step 824. If the determination at step 842 is in the negative, execution of step 824 ends without incrementing the counter value.

It is desirable to determine the first threshold value through experiments. The second threshold value may be 1 or larger and, typically, it is desirable to set the second threshold value to 1. It is noted, however, that the second threshold value depends on what expressions are used for filtering and, therefore, it is desirable to determine this value through experiments.

### B. Operation

Dialogue system 700 in accordance with the third embodiment has three operation phases. The first is a dialogue system 700 training phase. The second is a reference vector generation phase. The third is a dialogue phase that uses filtering unit 712. Of these, the training phase is as described with reference to the first embodiment. Therefore, here, the reference vector generation phase and the dialogue phase will be described in order.

### B1. Reference Vector Generation Phase

Referring to FIG. 11, expressions having high probability that inappropriate expressions appear therearound are collected beforehand as filtering expressions and stored in filtering expression storage unit 720. Reference vector generating unit 722 applies each of the filtering expressions to context model 80, obtains probability vectors output in response from context model 80, and stores them as reference vectors in reference vector storage unit 724. In this manner, for every filtering expression stored in filtering expression storage unit 720, a reference vector is generated and stored in reference vector storage unit 724 and then, the reference vector generation phase ends.

Naturally, in the present embodiment, reference vectors may be generated from any filtering expressions newly found after the operation of filtering unit 712 and added to reference vector storage unit 724.

### B2. Dialogue Phase

Dialogue engine 84 generates a plurality of system utterance candidates to an input utterance 82 (step 450 of FIG. 12), and applies them in the form of a system utterance candidate list to filtering unit 712 (step 452).

On each of the system utterance candidates (step 800), filtering unit 712 performs the following process (step 802). Filtering unit 712 first inputs each system utterance candidate to context model 80 (step 480) and thereby obtains its output probability vector (step 482). Filtering unit 712 inputs 0 to the variable representing the counter (step 820), and for each reference vector (step 822), performs the process of step 824.

At step 824, filtering unit 712 calculates cosine similarity between the system utterance candidate under processing and the reference vector under processing (step 840) and determines whether or not the value is equal to or larger than the first threshold value (step 842). If the cosine similarity is equal to or larger than the first threshold value, 1 is added to the counter at step 844, and the flow proceeds to the processing of the next reference vector. If the cosine similarity is smaller than the first threshold value, nothing is done and the flow proceeds to the processing of the next reference vector.

When the process of step 824 is completed on every reference vector in this manner, the counter will have stored the number of reference vectors of which cosine similarity with the system utterance candidate under processing is equal to or larger than the first threshold value.

Filtering unit 712 further determines whether or not the counter value is smaller than the second threshold value (step 826). If the counter value is smaller than the second threshold value, filtering unit 712 maintains the subject system utterance candidate (step 828) and starts processing of the next system utterance candidate. If the counter value is equal to or larger than the second threshold value, filtering unit 712 discards the subject system utterance candidate (step 830), and starts processing of the next system utterance candidate.

In this manner, filtering unit 712 determines whether each of the system utterance candidates is to be discarded or maintained, and for the system utterance candidates that are maintained, executes re-ranking process and outputs the system utterance candidate having the highest score as the system utterance 714 (FIG. 11).

As described above, in the dialogue system 700 of the present embodiment, not only the value of probability vector output from context model 80 is used but also the similarity between each of the plurality of reference vectors prepared beforehand and the system utterance candidate is calculated. If there is a prescribed number (the second threshold value) or more of the reference vectors of which calculated similarity is high, the system utterance candidate is discarded, and other system utterance candidates are maintained. The second threshold value may be 1 or larger, and for simplicity, the second threshold value may be set to 1.

As described above, in the third embodiment, while the context model similar to that of the first and second embodiments is used, the filtering method used is different from the first and second embodiments. By the third embodiment also, similar effects as the first and second embodiments can be attained.

In the third embodiment, for reference between the reference vector and the system utterance candidate, vector similarity is used. The present invention, however, is not limited to such an embodiment. Any value that can serve as a measure of similarity between two vectors may be used. By way of example, two vectors may be normalized, and then, both are regarded as position vectors and the distance between tip ends of these may be used as the measure of similarity. Alternatively, the sum of square errors between corresponding elements of normalized vectors may be used as the measure of similarity.

### 4. Computer Implementation

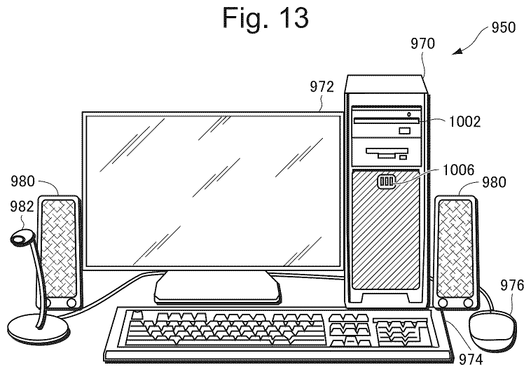

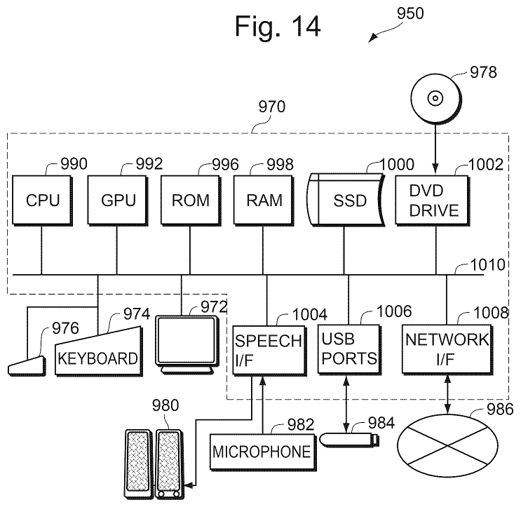

FIG. 13 shows the appearance of an exemplary computer system realizing the embodiments above. FIG. 14 is a block diagram showing an example of hardware configuration of the computer system shown in FIG. 13.

Referring to FIG. 13, the computer system 950 includes: a computer 970 having a DVD (Digital Versatile Disc) drive 1002; and a keyboard 974, a mouse 976 and a monitor 972, all connected to computer 970 for interaction with the user. These are examples of equipment when user interaction becomes necessary, and any other general hardware and software (for example, a touch-panel, voice input, pointing device and so on) allowing user interaction may be used.

Referring to FIG. 14, computer 970 includes: in addition to DVD drive 1002, a CPU (Central Processing Unit) 990, a GPU (Graphics Processing Unit) 992, a bus 1010 connected to CPU 990, GPU 992, and DVD drive 1002, a ROM 996 (Read-Only Memory) connected to bus 1010 for storing a boot-up program and the like of computer 970, a RAM (Random Access Memory) 998 connected to bus 1010, for storing program instructions, a system program and work data, and an SSD (Solid State Drive) 1000, which is a non-volatile memory connected to bus 1010. SSD 1000 is for storing programs executed by CPU 990 and GPU 992, data used by the programs executed by CPU 990 and GPU 992 and so on. Computer 970 further includes a network I/F (Interface) 1008 providing connection to network 986 allowing communication with other terminals; and a USB (Universal Serial Bus) ports 1006 to which a USB memory 984 may be detachably attached, providing communication with USB memory 984 and different units in computer 970.

Computer 970 further includes: a speech I/F 1004 connected to a microphone 982, a speaker 980 and bus 1010, reading out a speech signal, a video signal and text data, generated by CPU 990 and stored in RAM 998 or SSD 1000 under the control of CPU 990, to convert it into an analog signal, amplify it, and drive speaker 980, or digitizing an analog speech signal from microphone 982 and storing it in addresses in RAM 998 or in SSD 1000 specified by CPU 990.

In the embodiments described above, programs realizing various functions of dialogue system 50 shown in FIG. 1 and dialogue system 550 shown in FIG. 8 are stored, for example, in SSD 1000, RAM 998, DVD 978 or USB memory 984 shown in FIG. 14, or in a storage medium of an external device, not shown, connected through network I/F 1008 and network 986. Typically, the data and parameters are written from the outside to SSD 1000, for example, and at the time of execution by computer 970, loaded into RAM 998.

Computer programs causing the computer system to operate to realize functions of the dialogue systems 50 and 550 shown in FIGS. 1 and 8 and various components thereof are stored in DVD 978 loaded to DVD drive 1002, and transferred from DVD drive 1002 to SSD 1000. Alternatively, these programs are stored in USB memory 984 and when USB memory 984 is attached to USB ports 1006, the programs may be transferred to SSD 1000. Alternatively, the programs may be transmitted through network 986 to computer 970 and stored in SSD 1000.

Naturally, source programs may be input using keyboard 974, monitor 972 and mouse 976, and the compiled object programs may be stored in SSD 1000. When a script language is used, scripts input through keyboard 974 or the like may be stored in SSD 1000. For a program operating on a virtual machine, it is necessary to install programs that function as a virtual machine in computer 970 beforehand. Training and testing neural networks involve a huge amount of computation and, therefore, the program portion, which is the real part executing numerical calculation, may be provided not in script language but as an object program consisting of codes native to the computer, to realize various components of the embodiments.

At the time of execution, the programs will be loaded into RAM 998. CPU 990 fetches an instruction from RAM 998 at an address indicated by a register therein (not shown) referred to as a program counter, interprets the instruction, reads data necessary to execute the instruction from RAM 998, SSD 1000 or from other device in accordance with an address specified by the instruction, and executes a process designated by the instruction. CPU 990 stores the resultant data at an address designated by the program, of RAM 998, SSD 1000, register in CPU 990 and so on. At this time, the value of program counter is also updated by the program. The computer programs may be directly loaded into RAM 998 from DVD 978, USB memory 984 or through the network. Of the programs executed by CPU 990, some tasks (mainly numerical calculation) may be dispatched to GPU 992 by an instruction included in the programs or in accordance with a result of analysis during execution of the instructions by CPU 990.

The programs realizing the functions of various units in accordance with the embodiments above in cooperation with computer 970 may include a plurality of instructions described and arranged to cause computer 970 to operate to realize these functions. Some of the basic functions necessary to execute the instruction are provided by the operating system (OS) running on computer 970, by third-party programs, or by modules of various tool kits installed in computer 970. Therefore, the programs may not necessarily include all of the functions necessary to realize the system and method in accordance with the present embodiment. The programs have only to include instructions to realize the functions of the above-described various devices or their components by statically linking or dynamically calling appropriate functions or appropriate “program tool kits” during execution in a manner controlled to attain desired results. The operation of computer 970 for this purpose is well known and, therefore, the description thereof will not be repeated here.

It is noted that GPU 992 is capable of parallel processing and capable of executing a huge amount of calculation accompanying machine learning simultaneously in parallel or in a pipe-line manner. By way of example, parallel computational element found in the programs during compilation of the programs or parallel computational elements found during execution of the programs may be dispatched as needed from CPU 990 to GPU 992 and executed, and the result is returned to CPU 990 directly or through a prescribed address of RAM 998 and input to a prescribed variable in the program.

### 4. Modification

In the above-described embodiments, topic word list 74 is a list of words of which frequency of appearance in a passage group or the like is higher than a threshold value. The present invention, however, is not limited to such an embodiment. For example, a prescribed number of words of which frequency of appearance in a passage group is high may be listed. Other than such methods, it is also possible to form the topic word list 74 by extracting words included in expressions to be noted, which are collected manually in advance. Alternatively, words in a sum set or a product set of words having frequency of appearance in a passage group higher than a threshold value, or a prescribed number of words having high frequency of appearance, and words to be noted prepared manually in advance, may be listed as topic word list 74.

Further, in the above-described embodiments, types of words such as part of speech are not limited. The present invention, however, is not limited to such embodiments. Words may be limited in accordance with specific word classes (for example, verb, adjective, noun etc.) or, may be limited to so-called contents words. Further, not only the words but also so-called phrases may be added to topic word list 74.

In the above-described embodiments, BERT is used as the context model. The present invention, however, is not limited to such embodiments. A model based on an architecture other than BERT may be used as the context model.

The embodiments above are directed to a dialogue system. The present invention, however, is not limited to such embodiments. The present invention is applicable to any system that realizes human-system communication through dialogue, such as a question-answering system, interactive task-oriented system, or a response system to respond to a user message.

In the first embodiment described above, passages used for preparing the training data are not specifically limited. It is noted, however, that by preparing the training data from causalities, satisfactory results are obtained, as described in the second embodiment. Therefore, in the first embodiment, the training data may be formed by using passages including specific expressions such as causality.

In the second embodiment, causality is used. Causality is a combination of a cause phrase and an effect phrase. When an effect phrase of one causality is similar to a cause phrase of another causality, these two causalities can be linked. By such a link of causalities, two effect phrases can be obtained from the cause phrase of the first causality. Similarly, it is possible to relate three or more effect phrases to the first cause phrase. By using such a relation, as the context in the second embodiment, not only one effect phrase but two or more linked effect phases may be used to generate the training data.

The embodiments as have been described here are mere examples and should not be interpreted as restrictive. The scope of the present invention is determined by each of the claims with appropriate consideration of the written description of the embodiments and embraces modifications within the meaning of, and equivalent to, the languages in the claims.

### REFERENCE SIGNS LIST

50, 550, 700 dialogue system
60, 560 context model training system
62, 562 dialogue device
70 passage DB
72, 576 training data preparing unit
74 topic word list
76, 578 training data storage unit
78 training unit
80, 580 context model
82 input utterance
84 dialogue engine
86, 582, 712 filtering unit
88, 584, 714 system utterance
340 CLS token
342 SEP token
350 utterance
352 BERT
354 last hidden layer
356 CLS corresponding layer
358 fully connected layer
360 SoftMax layer
362 probability vector
400 training data
402 training utterance
404 ground-truth label vector
570 corpus
572 causality extracting unit
574 causality corpus
710 filtering vector generating unit
722 reference vector generating unit

1. An utterance filtering device, comprising:
a pre-trained context model trained, in response to an input of a word vector sequence representing an utterance, to output a probability vector comprising elements indicating probability of each of the words in a prescribed word group appearing in a context in which the utterance is placed; and
a determining means configured to input a word vector sequence representing a subject utterance to the context model, and to determine whether the subject utterance is to be discarded or approved depending on whether at least one element of the probability vector output by the context model in response to the input satisfies a prescribed condition.

2. The utterance filtering device according to claim 1, wherein the determining means includes a means for determining whether the subject utterance is to be discarded or approved, depending on whether a value determined as a prescribed function of at least one element of the probability vector is equal to or larger than a prescribed threshold value.

3. A dialogue system, comprising:
a dialogue device;
the utterance filtering device according to claim 1, coupled to the dialogue device to receive as an input an utterance candidate output from the dialogue device; and
an utterance filtering means for filtering the utterance output by the dialogue device, in accordance with the result of determination by the utterance filtering device.

4. A computer program causing a computer to function as:
a pre-trained context model trained, in response to an input of a word vector sequence representing an utterance, to output a probability vector comprising elements indicating probability of each of the words in a prescribed word group appearing in a context in which the utterance is placed; and
a determining means for inputting a word vector sequence representing a subject utterance to the context model, and based on the probability vector output from the context model in response to the input, for determining whether the subject utterance is to be discarded or approved depending on whether the probability of any word included in the prescribed word group is equal to or larger than a threshold value.

5. A training data preparing device, comprising:
a context extracting means for extracting context of the utterance for each utterance stored in a corpus;
a context vector generating means for generating a context vector representing whether or not each of the words included in a prescribed word group is appearing at least in the context; and
a training data preparing means for preparing training data by combining the utterance as an input and the context vector as an output, for each utterance stored in the corpus.

6. The training data preparing device according to claim 5, wherein
the corpus includes a plurality of causality expressions each including a cause part and an effect part; and
the context extracting means includes an effect part extracting means for extracting, for each of the plurality of causality expressions, the cause part of the causality expression as the utterance and the effect part of the causality expression as the context.
